(19) United States
(12) Patent Application Publication
(10) Pub. No.: US 2019/0118259 A1
(43) Pub. Date: Apr. 25, 2019

(54) HIGH-PRODUCTIVITY APPARATUS FOR ADDITIVE MANUFACTURING AND METHOD OF ADDITIVE MANUFACTURING

(71) Applicant: 3D NEW TECHNOLOGIES S.R.L., Rovereto (TN) (IT)

(72) Inventors: Mauro Varetti, Collegno (IT); Fabio Ferrario, Berlino (DE)

(21) Appl. No.: 16/093,047

(22) PCT Filed: Apr. 13, 2017
(86) PCT No.: PCT/IB2017/052139

§ 371 Date: Oct. 11, 2018

(30) Foreign Application Priority Data
Apr. 13, 2016 (IT) 102016000037941

(51) Int. Cl. B22F 3/10; B22F 3/105; B33Y 10/00; B33Y 30/00

(52) U.S. Cl. CPC B22F 3/1017; B22F 3/1055; B22F 2003/1056; B33Y 30/00; B33Y 10/00

(57) ABSTRACT

Apparatus for additive manufacturing includes: a platform adapted to receive a powder bed that is laid thereon; a laser source adapted to emit a laser beam towards the powder bed; a doctor blade adapted to move transversally relative to the platform in a direction parallel to the plane in which the powder bed lies, thereby moving the powder towards a work area, in which the laser beam progressively manufactures a product by sintering the layer of powder just deposited by the doctor blade; wherein the doctor blade is provided with at least one illuminator arranged in the lower part of the doctor blade itself, the at least one illuminator being an emitter with an emission range centered in the spectral region from 300 to 1000 nm.

### BACKGROUND OF THE INVENTION

### 1. The Field of the Invention

The present invention relates to an apparatus for additive manufacturing and to a method of operation thereof for the purpose of executing an additive manufacturing process.

### 2. The Relevant Technology

The term additive manufacturing refers to a process wherein three-dimensional design data are used for manufacturing a component by progressively laying multiple layers of material.

Additive manufacturing is a production technique that is clearly distinct from conventional methods based on material removal: instead of producing a semifinished product by starting from a solid block or by filling a mould in a single step, as is typical in foundries, components are built layer by layer starting from materials available as fine powder. Different types of materials can be used, in particular metals, plastics or composite components.

The process is started by laying a thin layer of powder material onto a work platform (bed). A laser beam is then used in order to melt the powder exactly in predefined locations according to the component design data. The platform is then lowered and another layer of powder is applied, and the material is melted again in order to bind it to the underlying layer in the predefined locations.

FIG. 1 shows an apparatus for additive manufacturing 1 according to the prior art.

Such apparatus comprises a laser source, associated optics for transmitting a beam, and scanner optics, designated as a whole by reference numeral 2, which are adapted to emit a laser beam 4 directed towards a powder bed 6.

The powder bed 6 is fed by a powder dispenser piston 6a, which feeds the powder, in a feed area 7, onto a first platform 6b. The dispenser piston 6a moves vertically upwards along a direction A as the powder is used.

A doctor blade 8 moves transversally relative to the first platform 6b in a direction B parallel to the plane in which the powder bed 6 lies, thus moving the powder from the feed area 7 towards a work area 10, wherein the laser beam 4 progressively creates a product 12 by melting the powder layer just laid by the doctor blade 8. In the work area 10 there are also a second platform 6b′, whereon the powder brought by the doctor blade 8 is laid, and a support piston 6a′, which lowers vertically in a direction C as the product 12 takes shape and increases in size.

In the work area 10 an emission opening and an opposite suction opening (not shown in the figure) are advantageously present, which are arranged transversally to the powder bed 6 and parallel to the plane in which a powder bed lies, for introducing a blade of a predefined gas, e.g., argon, and for sucking it in, respectively. The gas is used for cleaning the work area 10 from the vapours produced by evaporation of the powder; such vapours must not, in fact, be allowed to re-condense on the product 12, because this would lead to processing defects.

The apparatus of FIG. 1 is a static system that cannot easily grow in size for manufacturing big parts; as the dimensions of the product 12 increase, the dimensions of the emission opening and suction opening should also increase accordingly, but, if an excessively large gas blade is emitted, the gas will produce turbulences on the surface of the powder bed 6 that will not allow for optimal processing, since they will impair the uniformity and homogeneity of the powder bed 6.

Moreover, in the apparatus of FIG. 1 it is necessary, due to the fact that the laser source 2 is in a fixed position, that the doctor blade 8 completes the deposition of the powder bed 6 onto the platform 6b′ before the source 2 can be turned on and production of the product 12 can be started. Therefore, there are many intervals between one step and the next, which limit the productivity of the system, in that it is necessary to wait for the completion of the laying of a new powder bed before starting a new processing step.

Penetration and absorption of the laser beam in the powder bed are defined by the interaction between the laser beam itself and the powder bed, in particular by the energy absorption properties and the temperature of the powder bed.

The absorption properties of the material include density, thermal conductivity, specific heat and emissivity. These properties do not have constant values, but change with the temperature of the material itself. In particular, according to an additive manufacturing technique called selective laser sintering/melting, thermal capacity (the product of specific heat by the temperature difference between ambient temperature and melting temperature) can widely affect the process.

In addition to the above, it must be reminded that the quality of the manufactured parts is strongly dependent on the choice of the process parameters, such as laser power, laser scanning speed on the powder bed, shape of the laser beam, and material in use.

Pre-heating the powder bed immediately before the laser melting process can lead to faster execution time and less strains occurring during the hardening phase.

The properties of the material are therefore affected by the high thermal gradient in space and time resulting from the use of a laser beam in the melting process.

However, at present no devices have been developed yet which can provide suitable pre-heating of the powder bed in laser technology.

### SUMMARY OF THE INVENTION

It is therefore one object of the present invention to provide an apparatus for additive manufacturing which allows preheating the powder bed to bring it to a temperature close to the melting temperature, so as to reduce the thermal gradient and attain better temperature control, thereby improving the properties of the product and increasing the overall productivity and efficiency of the process.

It is a further object of the present invention to propose an innovative method of additive manufacturing.

These and other objects are achieved through an apparatus for additive manufacturing having the features set out in the independent claims.

Particular embodiments of the invention are set out in dependent claims, the contents of which should be understood as being an integral part of the present description.

### BRIEF DESCRIPTION OF THE DRAWINGS

Further features and advantages of the invention will be illustrated in the following detailed description, which is provided merely by way of non-limiting example with reference to the annexed drawings, wherein:

FIG. 1, already described, shows an apparatus for additive manufacturing according to the prior art; and

FIG. 2 shows an apparatus for additive manufacturing according to the present invention.

### DETAILED DESCRIPTION OF THE PREFERRED EMBODIMENTS

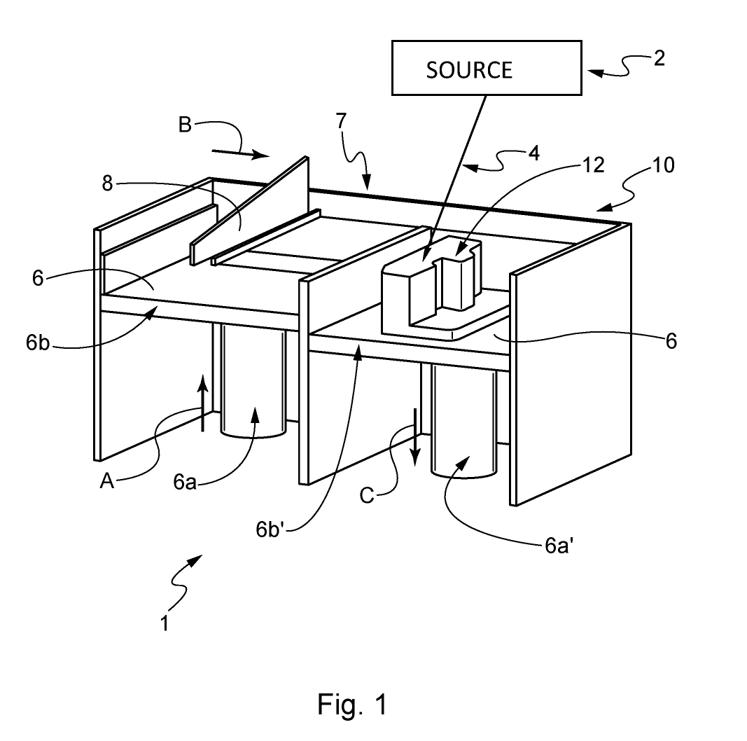

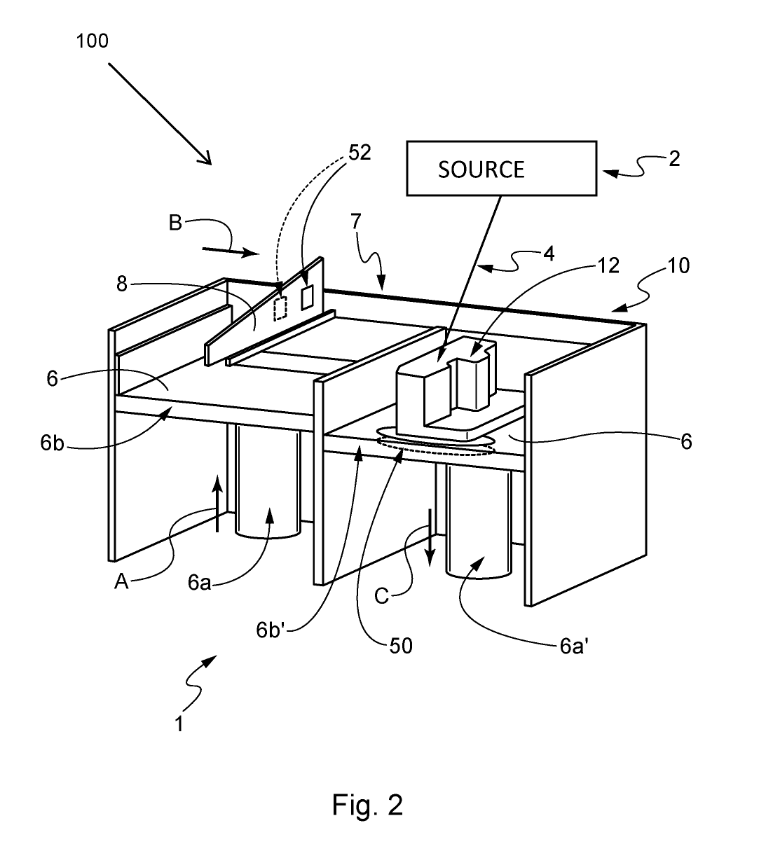

FIG. 2 shows an apparatus 100 for additive manufacturing according to the present invention. Those items which are similar to those shown in FIG. 1 are designated by the same references. Additional items will be described in detail below.

A detailed analysis of the total length of an additive manufacturing process allows identifying four times:
1. the time necessary for laying out the bed of material to be melted;
2. the time necessary for positioning the laser beam (galvanic scanner);
3. the time necessary for the material to melt;
4. the time necessary for resetting the process for processing the next layer.

By pre-heating the powder bed, the temperature of the metal powder of the bed is brought to a temperature closer to the melting temperature. The laser beam must, in fact, only melt the underlying material; therefore, it must yield to the material volume hit by the laser radiation only as much energy as necessary for increasing its temperature up to the material's melting point, and also yield the latent heat required for the isothermal phase transition. It is therefore apparent that such time is inversely proportional to laser power.

In this sense, the process becomes more productive, since only the latent heat of fusion needs to be supplied to the material via laser radiation.

Moreover, the pre-heating of the metal powder by laser immediately before the melting, and the post-heating of the product 12 after the melting, also ensure, in addition to higher productivity, better material properties and less residual strains caused by the cooling of the material just melted.

The simple melting and subsequent cooling of a thin layer of powder implies, in fact, extremely fast cooling that induces local strains, the importance of which grows with the dimensions of the cross-section of the product 12. It is in fact good practice to subject the product 12, when it is still anchored to the platform 6b (growth plate), to a thermal relaxation treatment to reduce the residual strains and ensure, after separation, that any deformations will fall within specific shape tolerances.

It must be pointed out that this phenomenon of induced strains and resulting deformations is typical of any hot processing of metallic materials, such as, for example, classic melting with associated backwelding and forging; therefore, it is not a peculiar feature of additive manufacturing.

By keeping the product 12 at sufficiently high temperatures it is possible to:
decrease residual hardening and cooling strains by reducing the temperature gradient;
decrease the amount of energy to be supplied by the laser to allow the product 12 to reach, in the region of co-melting with the powder layer, the desired melting temperature.

In order to make it possible to keep the product 12 at sufficiently high temperatures, the second platform 6b of the apparatus 100 is equipped with an induction system 50 of a per se known type, arranged under the platform 6b itself, for heating said second platform 6b and pre-heating the product 12 as it is being manufactured.

The energy required for melting the material, starting from the powder at ambient temperature, is divided into two parts: a greater first part, which allows increasing the temperature of the material up to the melting point; and a smaller second part, consisting of the latent heat of fusion.

The laser source 2 administers the second energy part while ensuring selectivity of the region of the product 12 to be melted.

The platform 6b with the induction system 50, jointly with one or more lamps or illuminators 52 associated with the doctor blade 8, supplies the first energy part.

In particular, the doctor blade 8 is provided with at least one illuminator 52 arranged in the lower part of the doctor blade 8 itself for pre-heating the powder bed and/or post-heating the product 12 as it is being manufactured.

Lamps must be selected by ensuring that the peak of their emission spectrum lies within a wavelength range (at a given temperature) with high values of absorption by the powder material.

For most metals, this corresponds to wavelengths shorter than 1 μm. The emission of most infrared radiators lies within a spectral region where metal absorption is marginal. It is therefore necessary to use systems allowing energy to be transferred as photons with sufficient energy. Lamps suitable for this purpose are gas lamps using electronic transitions. HID (High Intensity Discharge) lamps, as well as sodium-vapour lamps or metal-halide lamps, have an emission spectrum centered in the spectral region from 400 to 600 nm, where metal absorption is high and the energy transfer from the lamp to the metal powder is effective. In addition or as an alternative to these lamps, bars or stacks of laser diodes, e.g., 808 nm or 755 nm ones, may be used as well.

In this manner, three distinct processing phases can be obtained, i.e., powder pre-heating, temperature maintenance during the processing, and post-heating for relaxing strains locally induced in the thin hardening layer. Preferably, the illuminators 52 are lamps with associated reflectors, e.g., parabolic ones.

In one variant of the invention, the illuminators 52 are provided with CEC (Compound Elliptical Concentrator) reflectors made up of two ellipsoidal parts that allow directing the rays of the illuminators 52, through multiple reflections, towards the powder bed 6 with no loss of luminous energy and by exploiting all the energy emitted.

The melting step is thus separated into two sub-steps:
raising the temperature up to a value close to the melting point, by means of the platform 6b equipped with the induction system 50 and the lamps 52 (pre-heating system);
releasing the latent heat of fusion, via the laser beam 4, towards the material. The amount of energy released by the laser beam 4 for the melting step is thus lower than in prior-art apparatuses; therefore, the power of the laser source 2 being equal, the total time of the additive manufacturing process will be considerably shorter.

Thus, the above-described pre-heating and post-heating system differs from the known selective laser sintering and selective laser melting additive technologies in that the mechanical properties of the product are enhanced. The powder melting process occurs with minimal thermal stress, resulting in minimal induced strains and time of interaction between the laser radiation and the powder, resulting in a shorter production time. The post-heating process helps reduce the residual strains induced during the hardening phase.

The laser must release energy only to ensure the phase transition of the powder, and the work necessary for bringing the powder to the melting point is reduced in relation to the energy supplied by the lamps.

The above-described pre-heating and post-heating system is very advantageous, in particular, for processing aluminum through the use of fiber lasers emitting a typical wavelength of 1070 nm.

In this case, the material's absorption coefficient at ambient temperature is very low, and most of the laser power is usually lost during the process. Since the absorption coefficient increases with temperature, the time needed for the phase transition is drastically reduced.

Furthermore, the mechanical performance and final density of the product 12 depend on a uniform distribution of the powder particles and a reduction of the gaps between the particles. To this end, on the doctor blade 8 there is a piezoelectric transducer (not shown in the figure), which can induce vibrations in the doctor blade in at least the vertical direction to compress the powder as it is being laid by the doctor blade, thereby reducing the gaps between the particles.

The method of additive manufacturing according to the present invention is based on the use of the apparatus 100 and therefore comprises the steps of:
providing an apparatus 100 as previously described;
dragging the doctor blade 8 horizontally from the first platform 6b towards the second platform 6b′ in order to lay the powder while at the same time compressing it;
pre-heating the powder just laid by means of the lamps 52, said lamps contributing to heating the powder bed as the doctor blade 8 slides on the work area;
activating the source 2, so as to progressively manufacture the product 12;
sliding the doctor blade 8 back on the product 12 immediately after processing, thus post-heating the product 12 just made.

Alternatively, the powder may be pre-heated by means of the lamps only, without using the induction system.

The whole cycle is carried out continuously across the whole width of the second platform 6b, running in a first direction until the doctor blade 8 reaches an edge of the second platform 6b, and then in the opposite direction.

This process goes on until a predetermined number of progressively superimposed layers have been deposited, so as to build the three-dimensional shape of the product 12.

The heat supplied by the pre-heating system ideally brings the material to the edge of phase transition, and the activity of the laser beam 4 is ideally limited to supplying the latent heat of fusion.

The lamps 52 (and the induction system 50) contribute to keeping the temperature of the product 12 constant between one processing step and the next.

In one variant of the invention, the doctor blade 8 contains a powder dispenser; in this case, only the second platform 6b whereon the product 12 is made to grow will be used, instead of two distinct platforms.

The method according to the present invention comprises, therefore, the step of bringing the powder bed to a temperature close to the melting point (by means of the pre-heating system), and then supplying only the residual melting energy by means of the laser.

This treatment improves the properties of the material as well as the productivity and efficiency of the process as a whole. In fact, in this way it is possible to reduce the material melting time and the deformations induced in the product 12, thereby obtaining a better product in less time.

Of course, without prejudice to the principle of the invention, the embodiments and the implementation details may be extensively varied from those described and illustrated herein by way of non-limiting example, without however departing from the protection scope of the present invention as set out in the appended claims.

1. An apparatus for additive manufacturing, comprising:
a platform adapted to receive a powder bed that is laid thereon;
a fixed laser source adapted to emit a laser beam towards the powder bed;
a doctor blade adapted to move transversally relative to the platform in a direction parallel to the plane in which the powder bed lies, thereby moving the powder towards a work area, in which the laser beam progressively manufactures a product by sintering the layer of powder just deposited by the doctor blade;
wherein said doctor blade is provided with at least one illuminator arranged in the lower part of the doctor blade itself, said at least one illuminator being an emitter with an emission range centered in the spectral region from 300 to 1000 nm.

2. The apparatus for additive manufacturing according to claim 1, wherein said at least one illuminator comprises a first illuminator adapted to pre-heat the powder bed and a second illuminator adapted to post-heat the product as it is being manufactured.

3. The apparatus according to claim 1, wherein said at least one illuminator comprises a HID lamp and/or bars or stacks of laser diodes, with which parabolic or CEC reflectors are associated.

4. The apparatus according to claim 1, wherein said platform comprises an induction system arranged under the platform itself, which is adapted to heat said platform so as to pre-heat the product as it is being manufactured.

5. The apparatus according to claim 1, wherein the platform is supported by a piston adapted to move vertically.

6. The apparatus according to claim 1, wherein the doctor blade is provided with a piezoelectric transducer for inducing vibrations in at least the vertical direction, which are suitable for compressing the powder as it is being laid out.

7. A method of additive manufacturing, comprising the steps of:
providing an apparatus according to claim 1;
dragging the doctor blade horizontally on the platform in order to lay the powder while at the same time compressing it;
inducing vibrations in the powder in at least the vertical direction by means of a piezoelectric transducer arranged on the doctor blade, in order to improve the laying of the powder;
pre-heating the powder just laid by means of a first illuminator, said illuminator heating the powder bed as the doctor blade slides on the platform;
activating the laser source, so as to progressively manufacture the product;
sliding the doctor blade back on the product immediately after the latter has been manufactured, thus post-heating the product just made by means of said first or a second illuminator, wherein said doctor blade is provided with at least one illuminator arranged in the lower part of the doctor blade itself, said first and/or second illuminator being an emitter with an emission range centered in the spectral region from 300 to 1000 nm.

8. The method of additive manufacturing according to claim 7, wherein the temperature of the powder bed is raised by means of said first and/or second illuminator to a value close to the melting point, and the laser source only releases the latent heat required for the phase transition.
